(19) United States
(12) Patent Application Publication
(10) Pub. No.: US 2002/0085898 A1
(43) Pub. Date: Jul. 4, 2002

(54) Apparatus and method for segmented bending of wire binding elements

(76) Inventor: Hans-Peter Wurschum, Ostfildern (DE)

Correspondence Address: Kevin L. Leffel, Heidelberg Digital L.L.C., 2600 Manitou Road, Rochester, NY, 14624, US

(21) Appl. No.: 09/994,743

(22) Filed: Nov. 28, 2001

(30) Foreign Application Priority Data
Nov. 13, 2001 (EP) 01126528.7
Nov. 29, 2000 (DE) 10059344.5
Aug. 27, 2001 (DE) 10141811.6

(51) Int. Cl. B42B 5/08

(52) U.S. Cl. 412/7

(57) ABSTRACT

The invention is in the field of apparatus and processes for bending wire binding elements, which are used for binding brochures. According to various aspects of the invention, apparatus and methods are provided for bending wire binding elements to bind brochures.

### BACKGROUND

The invention is in the field of apparatus and processes for bending wire binding elements, which are used for binding brochures.

Procedures for loose binding of printed material in brochure format using Wire-O® binding elements, as they are called (registered trademark) in various sizes, are known e.g. from European patent applications EP 0 095 243 A1 and EP 0 095 245B1.

Wire-O® binding elements are configured as wire loops that are parallel to and separate from one another with a loop length L, a loop spacing A and a wire diameter D and are formed into a ring-like closure by means of suitable closing devices.

The binding equipment for the patent applications mentioned above are designed in a way that allows for the processing of preformed binding elements with different parameters like loop spacing and loop length. In this, the preformed binding elements consist of wire loops that, when seen from the side, form a series of semicircles in a C-shaped or ω-shaped structure. The C-shaped or e-shaped structure is compressed as to result in a circular ring binding after a stack of printed material is inserted with its perforations impaled by the wire binding element. The ω-shaped structure results after a crimp is placed in the center of the loops of the wire binding element. A crimp such as this can make the closing process for the preformed binding element easier.

Generally, the named devices have the disadvantage that, for loose binding of brochures of different formats and thickness, the wire binding elements have to be supplied to the wire binding device in the form of several preformed binding element supplies, e.g. as material wound on spools or as elements precut to the binding length. In order to be able to bind the different brochure formats and thickness, a considerable number of supplies are needed. In addition, if there is a change in the format of the brochures to be produced, the devices used for transport and processing must be adapted to the requirements of the different wire binding elements. This conversion requires costly designs of the transport and binding equipment, and therefore the binding process only becomes cost effective if a larger numbers of units of a given brochure format are produced. Small production runs are thus not cost-effective and require more time to adjust the equipment.

A procedure is known from the German patent DE 28 47 700 A1 for producing a wire binding for note pads, etc., in which a wire that is continuously pulled from a wire supply is shaped into a wave pattern by bending it back and forth, and whereby the wave-shaped wire structure is then bent into a C-shape perpendicular to the plane of the waves. Forming rollers with set diameters are used for bending so that only wire binding elements with unchangeable loop spacing and lengths are produced.

With a device for loose binding of brochures of different formats and sizes using wire comb binding, with which wire binding elements can be produced during the binding process as required and according to the respective format and thickness of the sheets of printed material to be bound in brochure format, each wire loop of the wire comb has to be compressed to form a ring. In this regard, it should be noted that the radius of the resulting ring depends on the thickness of the packet of the printed material to be bound and thus on the length of the respective wire loop.

### SUMMARY

According to various aspects of the invention, apparatus and methods are provided for bending wire binding elements to bind brochures.

### BRIEF DESCRIPTION OF THE DRAWINGS

FIG. 1 presents an embodiment of a brochure loosely bound using a single wire binding element, according to an aspect of the invention.

FIG. 2 presents an embodiment of a brochure loosely bound using several individual wire binding elements, according to an aspect of the invention.

FIG. 3 presents an embodiment of a book loosely bound using several individual wire binding elements arranged so that they are evenly spaced, according to an aspect of the invention.

FIG. 4 a representation of a wire binding element implemented in the practice of the invention.

FIG. 5 a schematic representation of a bending device, according to an aspect of the invention.

FIG. 6 presents a schematic representation of a process sequence according to one aspect of the invention.

### DETAILED DESCRIPITION

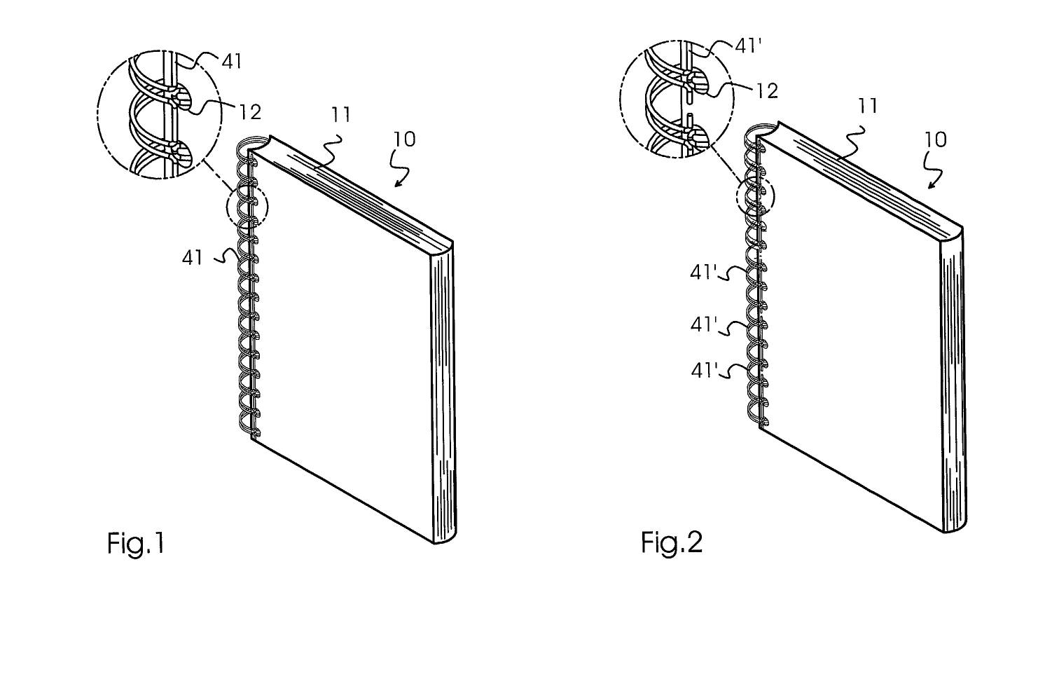

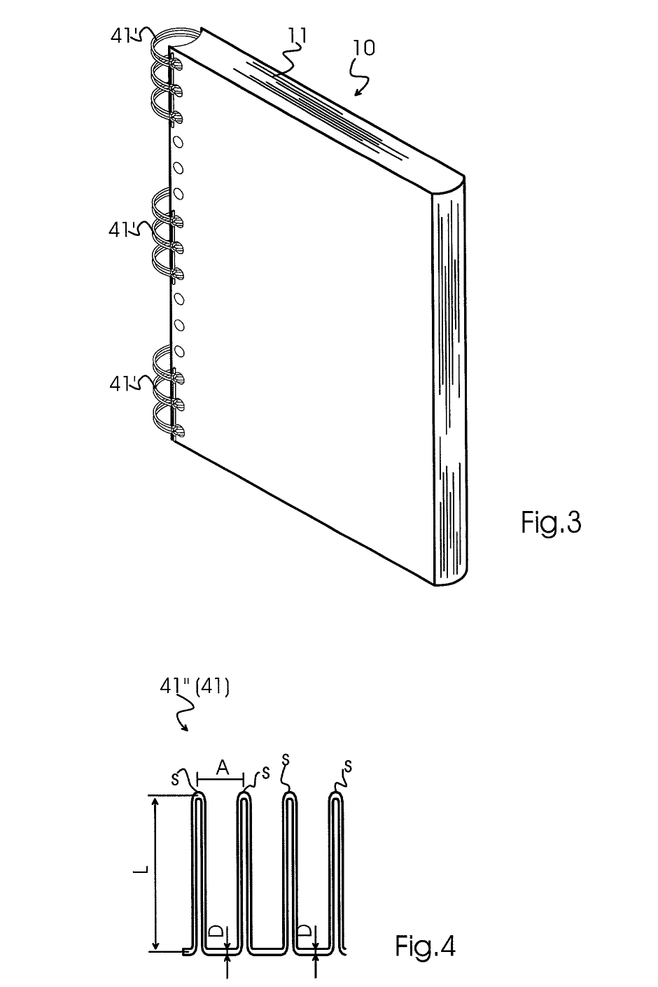

Various aspects of the invention are presented with reference FIGS. 1-6, which are not drawn to scale and wherein like components in the numerous views are numbered alike. Referring now to FIG. 1, a loosely bound brochure 10 which has a continuous binding is presented. FIG. 2 shows an individual binding that consists of wire binding elements 41′ which each have only a single loop, and for each hole 12 in the print medium exactly one wire binding element 41′ is used. FIG. 3 shows a wire comb binding that consists of several, e.g. multi-loop wire binding elements 41′ that are spaced from one another so that holes 12 remain open. Any other combination of the options mentioned is clear to the person skilled in the art, and is considered to fall within the purview of the invention.

Referring now to FIG. 4, a wire binding element 41″(41) of the type implemented in the practice of the invention is presented, have loops S with a loop length L, a loop spacing A, a wire diameter D and a number of loops N.

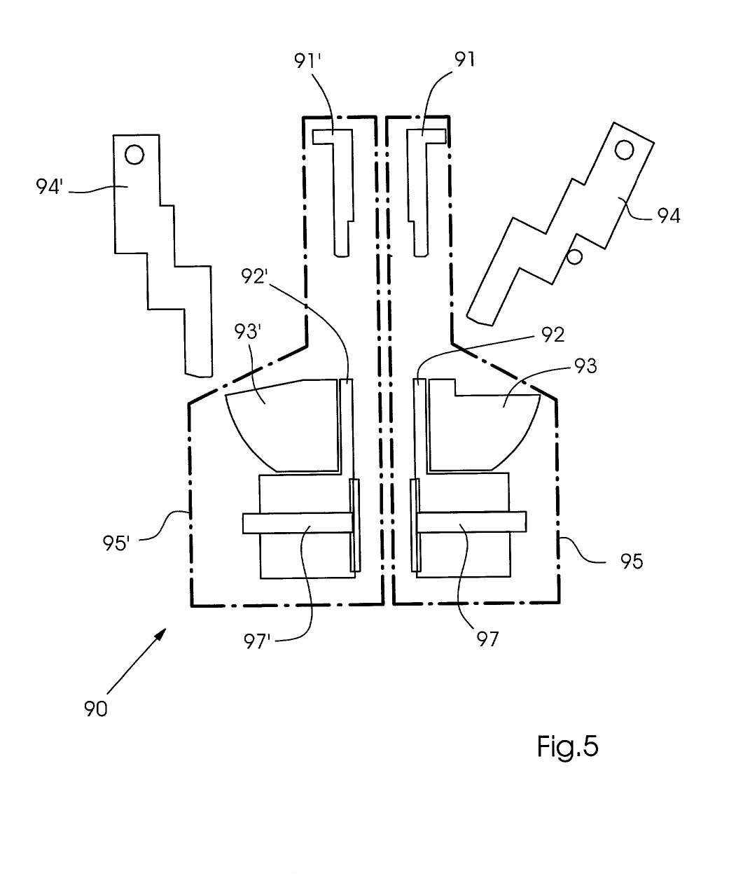

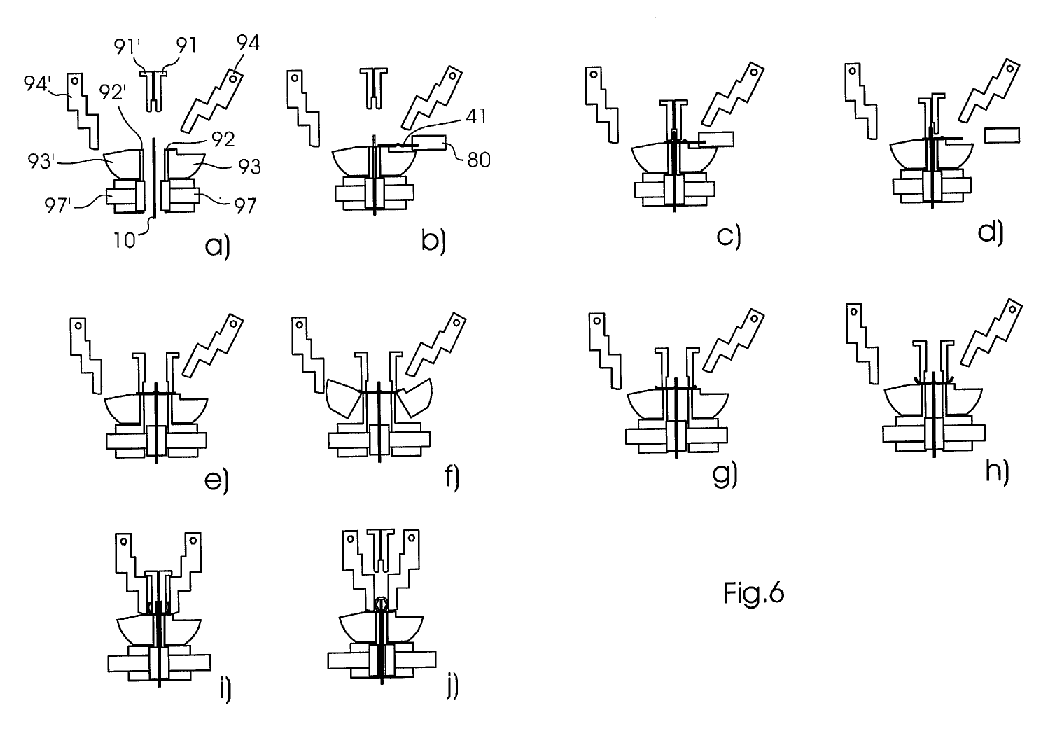

Referring now to FIG. 5 a device 90 is presented for carrying out a process according to one aspect of the invention. The device 90 has a first bending device 95 and a second bending device 95′ that is essentially symmetrical to it, which extends in the direction of wire binding elements 41, 41′, 41″ at a right angle to the wire loops S. The first and second bending device 95, 95 each comprises a first and/or second support 92, 92′ on which a flat, loop-shaped wire binding element 41, 41′, 41″ is placed, as well as a first and/or second holding device 91, 91′ that optionally clamps or releases the wire binding element 41, 41′, 41″ in combination with the assigned first and/or second support 92, 92″. The holding devices 91, 91′ are mounted such that, on one hand, they can move perpendicular to the wire binding element 41, 41′, 41″ to clamp or release wire binding element 41, 41′, 41″. The holding devices 91, 91′ may be driven in various ways, within the skill of an artisan in the mechanical arts, without limitation, for example by stepper motors with suitable control and guide means, which are not shown for the sake of clarity.

The first and/or second bending device 95, 95′ also comprises a first and/or second bending bar 93, 93′, which preferably extends at least over the entire loop width, which essentially corresponds to the distance A between two loops of a wire web 41″, along the first and/or second wire binding element 41, 41′, 41″. According to a preferred embodiment, the first and/or second bending bar 93, 93′ extends over the entire length of the wire binding element, i.e. over the entire number N of wire loops which make up the wire web 41″. The first and/or second holding device 91, 91′ is designed in such a way that each wire loop S is assigned to a first or second holding device 91, 91′. A first and/or second common holding device 91, 91′ can also be implemented for all wire loops S that are bent with a first and/or second bending device 95, 95′.

The first and/or second bending device 95, 95′ is mounted and driven in such a way that the first and/or second bending device 95, 95 with all the components 91, 91′, 92, 92″, 93, 93′, can be slid in a controlled manner along the length L of wire loops S of wire binding elements 41, 41′, 41″. The sliding of the bending devices is essentially symmetrical to the center of the inserted wire binding elements 41, 41′, 41″. This sliding is used, as described further below, to approach the different bending positions for bending the individual segments. The mounting, the drive and the control are not shown for the sake of clarity, but they are standard commercial elements known to a person skilled in the mechanical arts for mounting, drive and control of mechanical components.

Independently of the first and/or second bending device 95, 95′, first and/or second fixed stamps 97, 97′ are provided for tightly holding a brochure to be bound, for example several sheets of printed material 11, during the bending process.

The device 90 for carrying out the process according to the invention also has a first and/or second O former 94, 94′ that bend the loop-shaped wire binding element 41, 41′, 41″, which is bent into a C-shape, into an essentially round O-shape. The first and/or second O formers 94, 94′ are mounted so that they can rotate and are also equipped with control, drive and guide means (not shown) of a type known in the mechanical arts. The function of the O formers will be described in more detail in the following.

Referring to FIG. 6, a process is schematically presented according to one further aspect of the invention. The initial position of the device 90 at the beginning of the process is presented in FIG. 6a, in which all the movable elements are located at initial positions. A brochure is already located between the first and/or second bending devices 95, 95′ in such a way that a continuous series of perforations 12 is found in the brochure 10 essentially at the top of the first and/or second supports 92, 92′.

In a first step, FIG. 6a, the two bending devices 95, 95′ are operated together. The the bending devices 95, 95′ move towards the packet of printed material 11 with stamps 97, 97′ that clamp the brochure 10 and remain fixed in this position during the rest of the procedure.

As shown in FIG. 6b, the wire binding element 41, 41′, 41″ is guided by an insertion device 80 up to the first support 92 so that the closed ends of the wire loops come to rest on the support. in a next step, FIG. 6c, the two holding devices 91, 91′ are moved towards the wire binding element 41, 41′, 41″ without clamping it. The holding devices 91 and 91′ are brought down as an aid for inserting the wire binding element 41, 41′, 41″. The insertion device 80 then inserts the wire binding element 41, 41′, 41″ through the series of perforations of the packet of printed material 11 until the closed end of the wire binding element 41, 41′, 41″ comes to rest on the contact surface of the other support 92′. In a following step, FIG. 6d, the wire binding element 41, 41′, 41″ is clamped onto the second support 92′ with the second holding device 91′. The second holding device 91′ is now in the first bending position, i.e. the free end of the wire binding element 41, 41′, 41″ outside the second holding device 91′ essentially corresponds to the first segment length. In a following step, FIG. 6e, the second bending unit 95′, together with the clamped wire binding element 41, 41′, 41″, moves away from the packet of printed material 11 and in the process the wire binding element 41, 41′, 41″ is pulled further through the series of perforations 12 of the packet of printed material 11. The movement ends when the wire binding element 41, 41′, 41″ is essentially symmetrical in the packet of printed material 11, i.e. the center of wire loops S essentially corresponds with the center of the packet of printed material 11. Afterwhich, the first holding device 91 clamps end of wire loop S opposite the end already held by the second holding device 91′. The wire binding element 41, 41′, and 41″ is now secured in a first bending position with approximately equal portions on both sides of the brochure 10. Segments of essentially the same length are thus provided on both sides of the wire loop (see FIG. 6e).

In a following step, FIG. 6f, the first and/or second bending bar 93, 93′ is rotated upward around the respective first and/or second holding device 91, 91′ by an angle typically between 250 and 350. A bending of 30° is particularly preferred. Because of the swiveling of the first and/or second bending bar 93, 93′, the first free end of the wire loop S of the wire binding element 41, 41′, 41″ is bent upward by the respective angle and forms the first segment.

After the first segment is bent, the first holding device 91 is raised and both bending devices 95 and 95′ are moved half a segment inward toward the brochure 10, to the position shown in FIG. 6g. In the embodiment presented, this is accomplished by unclamping the binding wire element in bending device 95′, and then moving the device 95 a segment length with the wire binding element still clamped to bending device 95 (see FIG. 6h). Then bending device 95′ clamps the binding element and the bending device 95 releases the wire binding element, and the bending device 95′ is moved a segment length toward the brochure 10. In such manner, the wire loop S is moved a segment length in opposite directions, but remains to the center of the packet of printed material 11. Both bending devices 95 and 95′ are now in the second bending position. In the next step, FIG. 6h, the bending device 95 clamps the binding element, and the bending element is now clamped in both bending devices 95 and 95′. Naturally, the sequence of closing and opening of the first and/or second holding device 91, 91′ can be reversed so that at first the second holding device 91′ is raised, etc. The only thing that is important is that because the wire binding element 41, 41′, 41″ is slid twice by the same distance in opposite directions, the wire binding element 41, 41′, 41″ is ultimately located in the same position as before (the bending devices could be moved multiple times partial segment lengths, for example twice at half segment lengths).

The embodiment just described is particularly useful if the bending devices 95 and 95 are interconnected in a manner wherein they always move together. If the bending devices are configured to move independently, the binding element may be clamped by one device 95 or 95′ while the other binding device 95 or 95′ is moved a full segment inward. This process is completed twice, once for each binding device 95 and 95′, and avoids moving the binding element.

Other segments are created by repeating the last few steps. In this process, the last segment is advantageously bent by an angle of only 15° which results in better behavior during a subsequent step for closing the wire binding element 41, 41′, 41″, which is now present in a C-shape, to a completely closed Wire-O ring.

FIG. 6i shows the position of the elements of the device for carrying out the procedure according to an aspect of the invention for closing the wire binding element 41, 41′, 41″, which is now present in a C-shape, to a completely closed ring-like binding. The first O-former 94 swings downward and is moved so that it approaches the wire binding element 41, 41′, 41″ present in a C-shape. Before that, the first O-former 94 was in a swiveled-up position, making it possible to insert the wire binding element 41, 41′, 41″ into the series of perforations 12 of the packet of printed material 11. The second O-former 94′ also moves laterally to the wire binding element 41, 41′, 41″ so that the C-shaped wire binding element 41, 41′, 41″ is lightly clamped between the first O-former 94 and the second O-former 94′. After that, both holding devices 91, 91′ are raised so that it is possible to completely close the wire binding element 41, 41′, 41″ (see FIG. 6j). After that, the two O-formers are moved closer to one another to attain a completely closed ring-like binding. Finally, all the components of the device return to their initial positions and the stack of printed materials which is now loosely bound can be taken out of the device.

According to one aspect of the present invention, a device is provided for carrying out a procedure, whereas said device is equipped with a first bending unit and a second bending unit, each bending unit comprising at least one holding device, one support and one bending bar, whereby the first bending unit and the second bending unit can be moved individually and in a controlled manner along the loop of the wire binding elements.

According to a further aspect of the invention, the holding device, together with the support, clamps the wire binding element while the bending bar revolves, bending the free end of the wire binding element around the holding device by a specified angle. The holding device may be configured appurtenances that aid bending, which decrease the amount that the bent wire segment springs back.

According to a further aspect of the invention, after the bending of a segment, each bending unit moves in succession toward the other by a partial or whole segment length in order to hold the wire binding element again, whereby the wire binding element remains constantly clamped on one side during the closure. In this process, the wire binding element is clamped alternately and closed so that the wire binding element remains essentially symmetrical in the center between the bending devices.

In a particularly preferred embodiment, before bending, a flat, loop-shaped wire binding element is guided though a series of perforations running along one edge of a packet of printed material to be bound in brochure form such that the packet of printed material is located between the bending units during the bending process. In this case, the wire binding element is bent when a packet of printed material is located essentially midway between the bending jaws. In its flat form, the wire binding element is inserted into the series of perforations along the edge of the packet of printed material to be bound in brochure form. This simplifies inserting the wire binding element. Even more advantageously, while the procedure is being carried out, the packet of printed material to be bound may be held by a clamping device, for example by pincers or two stamps acting in opposite directions or similar, such that the series of perforations do not move for the duration of the process and the packet of printed material does not restrict the sliding of the wire binding element along the wire loops.

According to a further aspect of the invention, the device for carrying out the procedure is equipped with two units for achieving the O-shape (O-formers), by means of which after bending of the segments, the wire binding element bent in segments into a C-shape can be bent into a complete O-shape, i.e. into an essentially circular, segmented shape such that the packet of printed material is loosely bound in brochure form. With this procedure it is also possible to close a previously flat wire binding element for loosely binding a packet of printed material in brochure format to create a complete wire comb binding element, whereby the wire binding element is already inserted into the packet of printed material during the entire process.

In a preferred embodiment, the length of the segments results from the loop length of flat wire binding elements, which specifies the radius of the bent ring. The number of segments also results from the radius of the bent ring, essentially for esthetic reasons, in order to give the segmented bent ring an appearance that is as round as possible. Optionally, four to seven facets are bent on both sides of the center of the wire binding element.

According to a further preferred embodiement, the free ends of the wire binding element are bent 30+ during segment bending and the free ends of the wire binding element are bent 15° during bending of the last segment. In this way, improved stability of the rings can be achieved, if after the segmented bending, the C-shaped wire binding element is compressed into a ring using the O former. Other bending angles are also possible within the scope of the process according to the invention.

In a particularly preferred embodiment, the segments are bent in succession, starting from the outside of the wire binding element.

According to a further aspect of the invention, electronics may be used to determine the length of the segments and the number of segments in relationship to the loop length of the wire binding element. Electronics may also be advantageously used to control the movement sequence of the bending devices, especially precise approach of the bending positions, from which the length of the segments result. A cam control or electronically-controlled stepper motors can also be used to control the movement sequence, i.e. the alternating clamping and bending of the wire binding element. In contrast to this, the approach of the bending positions is advantageously carried out only by electronically-controlled stepper motors in order to achieve the greatest possible flexibility in the selection of number of segments and length of segments in the bent C-shaped wire binding elements. In an advantageous manner, the segments of the C-shaped wire binding element all have the same length in order to give the bent ring of a wire comb binding the roundest possible appearance, but different segment lengths can be planned as well.

According to a further aspect of the invention, the initial position of at least one of the stops and/or the holding devices and/or the bending bars is calibrated by means of a zero point sensor before each new wire binding element to be bent. Because of this, it can be assured that the bending positions can be approached precisely each time a bending procedure is carried out on a new, flat, loop-shaped wire binding element so that the length of the individual segments of the wire binding element bent to a C-shape correspond to the specifications of the control electronics.

According to a particularly preferred embodiment, the bending of a segment is carried out simultaneously on all wire loops of a wire binding element. The parallel bending of all wire loops of a wire binding element for a wire comb binding considerably accelerates the processing of the wire binding element. In addition, it can be ensured that all the segments have the same bending positions along the wire binding element. Because of this, a complete wire comb binding with a segmented bent wire comb has a more esthetic external appearance and improved functionality, especially when the pages are turned in a loosely bound brochure with a wire comb binding produced in this manner. Within the scope of the process according to the invention, using bending bars divided along the wire binding element, with which e.g. part, for example half or one-third of all the wire loops of a wire binding element are bent at the same time is also possible, in order to reduce the forces that occur in the process. Other divisions of the bending bars are also conceivable.

An example of binding system that implements the apparatus and processes of the present invention is disclosed in a U.S. patent application Ser. No. x/xxx,xxx filed on even date herewith, entitled BINDING PROCESS FOR MANUFACTURING BROCHURES, naming Blattner et al. as inventors. A suitable binding element forming device is disclosed in U.S. patent application Ser. No. x/xxx,xxx filed on even date herewith, entitled BINDING APPARATUS AND METHOD, naming Mario Litsche as inventor. The contents of both of these applications are hereby incorporated by reference, as if set forth herein. In referencing these applications, it is not intended to limit the invention to the specific embodiments disclosed, since it is evident that numerous variations and additional embodiments are possible.

Although the invention has been described and illustrated with reference to specific illustrative embodiments thereof, it is not intended that the invention be limited to those illustrative embodiments. Those skilled in the art will recognize that variations and modifications can be made without departing from the true scope and spirit of the invention as defined by the claims that follow. It is therefore intended to include within the invention all such variations and modifications as fall within the scope of the appended claims and equivalents thereof

What is claimed is:

1. A process for bending a wire binding element used in binding brochures comprising bending said wire binding element into a concave shape in segments.

2. The process of claim 1, comprising bending said wire bending element a determined angle.

3. The process of claim 1, comprising bending said wire binding element an angle in the range from 15° to 35°.

4. The process of claim 1, comprising bending said wire binding element an angle in the range from 25° to 35° a plurality of times, and bending said wire binding element 15° a final time.

5. The process of claim 1, further comprising closing said wire binding element.

6. The process of claim 1, further comprising inserting said wire binding element into said brochure.

7. The process of claim 1, further comprising inserting said wire binding element into said brochure and closing said wire binding element.

8. The process of claim 1, further comprising inserting said wire binding element into said brochure and subsequently closing said wire binding element.

9. The process of claim 1, further comprising calibrating an initial position of said wire binding element.

10. The process of claim 1, further comprising starting said bending from an outer periphery of said wire binding element.

11. An apparatus for bending a wire binding element used in binding brochures comprising:
a base; and,
a bending unit connected to said base configured to bend the wire binding element into a concave shape in segments.

12. The apparatus of claim 11, further comprising a clamping device that holds the wire binding element for said bending unit.

13. An apparatus for bending a wire binding element used in binding brochures, comprising:
a base;
a first bending unit connected to said base; and,
a second bending unit connected to said base, each bending unit comprising at least one holding device, one support and a bending bar;
wherein said first bending unit and said second bending unit can be translated individually along a wire loop of the wire binding element.

14. The apparatus of claim 13, wherein the holding device, together with the support, clamps the wire binding element and the bending bar bends the free end of the wire binding element around the holding device by a specified angle by means of rotation.

15. The apparatus of claim 13, further comprising two O formers configured to bend said wire binding element into a ring-like binding.

16. The apparatus of claim 13, further comprising sensors positioned to detect the initial position of at least one of the supports and/or of at least one of the holding devices and/or at least one of the bending bars.

17. The apparatus of claim 13, wherein said bending device is configured to bend all loops of a binding element having multiple loops.

18. The apparatus of claim 13, wherein said bending device is configured to bend a subset of loops of a binding element having multiple loops.

19. The apparatus of claim 13, further comprising an insertion device that inserts the wire binding element into the brochure.

20. The apparatus of claim 13, further comprising an insertion device that inserts the wire binding element into the brochure adjacent at least one of said bending units.
